(19) United States
(12) Patent Application Publication
(10) Pub. No.: US 2006/0215073 A1
(43) Pub. Date: Sep. 28, 2006

(54) Liquid Crystal Display power-driven structure

(76) Inventor: Chun-Chieh Liao, Taipei (TW)

Correspondence Address: Chun-Chieh Liao, P.O. Box 44-2049, Taipei, 10668, TW

(21) Appl. No.: 11/076,910

(22) Filed: Mar. 11, 2005

(51) Int. Cl. G02F 1/1333; F16H 27/02

(52) U.S. Cl. 349/58; 74/89.23

(57) ABSTRACT

A Liquid Crystal Display (called LCD as following) power-driven structure comprises a rotating mechanism, a lifting mechanism and an adjusting mechanism with a power unit each. The power unit drives the gears of the rotating mechanism to adjust the lateral angle of the LCD, the gears of the lifting mechanism to adjust the height level of the LCD and the gears of the adjusting mechanism to adjust the pitch angle of the LCD. The LCD power-driven structure overcomes the drawbacks of the prior technique and accomplishes the purpose of adjusting the LCD to any required posture without manual effort for saving a user's energy and improving the convenience.

### BACKGROUND OF THE INVENTION

1. Field of the Invention

This invention relates to a Liquid Crystal Display (called LCD as following) power-driven structure which more particularly comprises a rotating mechanism, a lifting mechanism and an adjusting mechanism that each is driven by an independent power unit for adjusting the lateral angle, the pitch angle and the height level automatically on the purpose of improving utility and operating convenience.

2. Description of the Prior Art

A prior LCD I, shown as FIG. 1, comprises a fixed supporter 11 linked to an un-adjustable monitor 12 and is put on a cabinet or a table for using. As a user does not sit on the straight direction of facing the prior LCD 1, he/she usually can't see the program or read the words on it because the reflection of lights impacts the user's visual performance. It's necessary to move the prior LCD 1 to a suitable angle position. If the prior LCD 1 is very large or heavy, it could cause the user a lot of strength to make a movement. This is very easy to induce the user's injury or the prior LCD 1 damage during the adjusting action.

Furthermore, as the height difference between the user sitting posture and the prior LCD 1 on a cabinet or a table is great, it easily causes the user's visual fatigue. So, it is necessary to move the prior LCD 1 to a higher or lower place for using. This is also easily result in personal injury or the prior LCD 1 damage during the moving action.

Therefore, considering of the defects and the inconvenience of the prior LCD 1 mentioned as above, this invention is created to increase the value and the range of substantial utility by inventor's professional knowledge and spirit of pursuing innovation and perfecting.

### SUMMARY OF THE INVENTION

This invention provides a technique solution as: a LCD power-driven structure. The LCD power-driven structure comprises a rotating mechanism, a lifting mechanism and an adjusting mechanism. The rotating mechanism includes a pedestal fixed on a monitor bracket of a monitor. A pivot trough set on the pedestal joins a bearing which has a gear part driven by a rotating gear. A pivot hole is set on the gear part and is corresponding to a hollow of the bearing and a hollow of the pivot trough. A shaft is inserted through the pivot hole and the hollows for fixing. And the shank also penetrates a bearing and a hollow of a cover. The lifting mechanism contains a box with a pivot trough set on the cover. The pivot trough is penetrated by the shank and joins a rotating bearing. A gear driven by an electrical thread gear is set around the surface of the rotating bearing. A box lid is set on the rotating bearing. An axle tube is set on the box lid for the shank penetrating through and into the rotating bearing. And a tube set on the shank joins the axle tube tightly. The adjusting mechanism comprises a base set on one end of the tube. A left gearbox and a right gearbox are set on each opposite side of the base. A power gear is set inside the left gearbox. A fixed part is set between the left gearbox and the right gearbox and a toothlike adjuster driven by the power gear is extended from the fixed part. The rotating mechanism, the lifting mechanism and the adjusting mechanism are connecting to a power unit each. The power unit of the rotating mechanism makes the rotating gear to drive the gear part for adjusting the lateral angle of the LCD. The power unit of the lifting mechanism makes the electrical thread gear to drive the gear around the rotating bearing and then makes the tube which joins tightly with the axle tube to move vertically for changing the height position of the LCD. The power unit of the adjusting mechanism makes the power gear to drive the toothlike adjuster of the fixed part to adjust the pitch angle of the LCD.

The embody shape of the gear part of the rotating mechanism could be sector or round.

About the rotating gear of the rotating mechanism mentioned above, it comprises an electrical thread gear, a small gear, a small thread gear and a gear axle. The electrical thread gear is set near the gear part and is fixed inside a setting part set on the pedestal. The both ends of the gear axle penetrating the small gear and the small thread gear are set in a clipping part inside the pedestal. And a containing part is set inside the box for joining the electrical thread gear of the lifting mechanism.

The pedestal contains also a hooking post connected to one end of an elastic part. The other end of the elastic part is clipped on one end of the gear axle. This can protect the gear part from teeth cracking by separating from the small thread gear as receiving a huge force.

About the shank of the lifting mechanism mentioned above, an inserting hole is set on one end of the shank with a latch inserted into for avoiding the axle tube escaped from the end of the shank.

A hole is set on the box lid and an opening is set on the side of the hole. The opening is corresponding and props to a prominence set on the side of the tube. A fixed hole set on the axle tube is corresponding tightly to a fixed hole set on one end of the tube fixed with a latch or a bolt.

The power unit as mentioned above could be a contact switch type or a remote controlled switch type.

The principal object, also the feature, of this invention is: the power units set on the rotating mechanism, the lifting mechanism and the adjusting mechanism. By driving the gears set on above mechanisms with the power units, it is very easy for a user to adjust the lateral angle, the pitch angle and the height position without any manual effort. This invention improves the economic benefits of the convenience and the utility of a prior LCD.

### BRIEF DESCRIPTION OF THE DRAWINGS

FIG. 1 is an assembly perspective view of a prior LCD monitor;

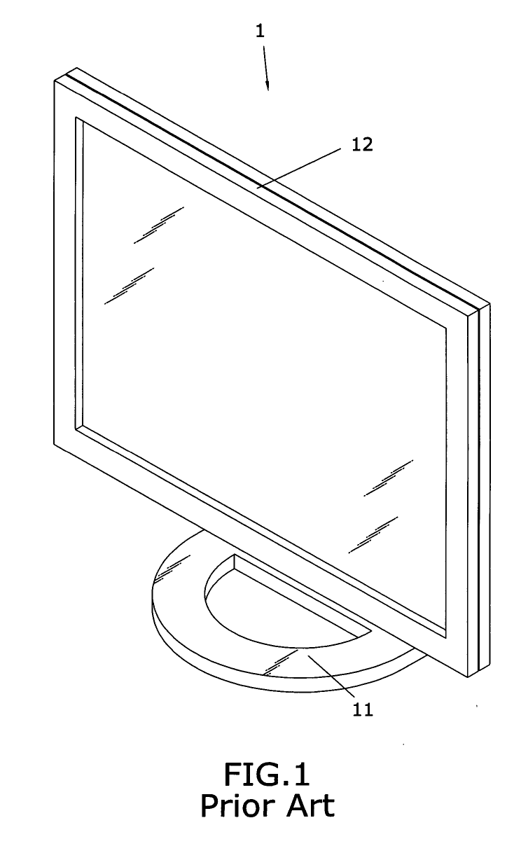

FIG. 2 is an exploded perspective view of the rotating mechanism and the lifting mechanism of a preferred embodiment of the present invention;

FIG. 3 is an exploded perspective view of the adjusting mechanism of a preferred embodiment of the present invention;

FIG. 4 an assembly perspective view of the rotating mechanism, the lifting mechanism and the adjusting mechanism of a preferred embodiment of the present invention;

FIG. 5 illustrates the preferred embodiment of the present invention of the rotating mechanism in an operating position;

FIG. 6 illustrates the preferred embodiment of the present invention of the lifting mechanism in an operating position;

FIG. 7 illustrates the preferred embodiment of the present invention of the adjusting mechanism in an operating position.

### DESCRIPTION OF THE PREFERRED EMBODIMENTS

This invention comprises a rotating mechanism 2, a lifting mechanism 3, a adjusting mechanism 4 and three power units 5.

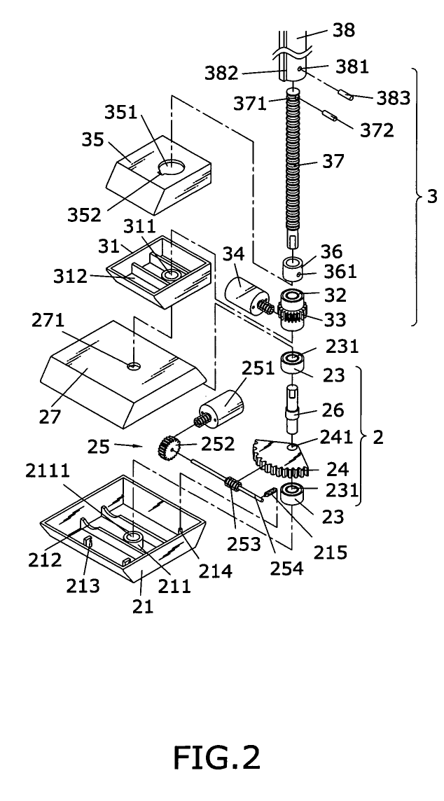

Referring to the FIG. 2, a rotating mechanism 2 contains a pedestal 21 which is fixed on a bracket 22 of a monitor. The pedestal 21 includes a pivot trough 211 used to join a bearing 23. The bearing 23 contains a gear part 24 which is driven by a rotating gear 25. A pivot hole 241 is set on the gear part 24 and is corresponding to a hollow 231 on the bearing 23 and a hollow 2111 on the pivot trough 211 which are inserted by a shaft 26 thoroughly for fixing. And the other end of the shaft 26 is inserted into a hollow 231 on another bearing 23 and a hollow 271 of a cover 27 for fixing.

The embody shape of the gear part 24 can be sector or round. And the rotating gear 25 comprises an electrical thread gear 251, a small gear 25, a small thread gear 253 and a gear axle 254. A setting part 212 is set on the pedestal 21 for fixing the electrical thread gear 251 near the gear part 24. The both ends of the gear axle 254 are fixed in a clipping part 213 of the pedestal 21 after penetrating the small gear 252 and the small thread gear 253. A hooking post 214 is installed in proper place inside of the pedestal 21 for hooking one end of an elastic part 215. And the other end of the elastic part 215 is hooked on one end of the gear axle 254. As receiving a huge outside force, the gear part 24 is separated from the small thread gear 253 for avoiding the teeth of the gear part 24 cracked.

Furthermore, a lifting mechanism 3 comprises a box 31 which is set on the cover 27. A pivot trough 311 set on the box 31 is penetrated by the shaft 26 and is joined with a rotating bearing 32. A gear 33 set around the rotating bearing 32 is driven by an electrical thread gear 34. An axle tube 36 is set on the box lid 35 which is set on the rotating bearing 32 for penetrating a shank 37 through and into the rotating bearing 32. A tube 38 is covered the shank 37 and is joined tightly with the axle tube 36.

A containing part 312 is set inside of the box 31 for fixing the electrical thread gear 34. And an inserting hole 371 is set on one end of the shank 37 for inserting a latch 372 to avoid the escaping of the axle tube 36. A hole 351 is set on the box lid 35 and an opening 352 is set on side of the hole 351. The opening 352 is corresponding and propping a prominence 382 which is set on one side of the tube 38. And a fixed hole 381 set on this end of the tube 38 is corresponding tightly to a fixed hole 361 set on the axle tube 36, and the fixed-holes 381, 361 are penetrated by a latch 383 or a bolt for fixing.

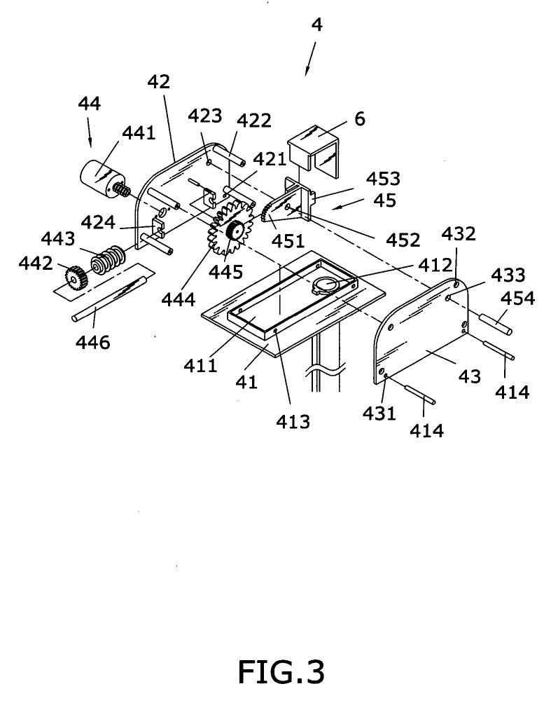

Referring to the FIG. 3, an adjusting mechanism 4 contains a base 41 which is mounted on one end of the tube 38. A left gearbox 42 with a power gear 44 and a right gearbox 43 are set correspondingly on each opposite side of the base 41. A fixed part 45 is set between the left gearbox 42 and the right gearbox 43, and a toothlike adjuster 451 extended from the fixed part 45 is driven by the power gear 44.

A placing part 411 is set on the proper place of the base 41 for putting the left and right gearboxs 42, 43 and the power gear 44 IN. On the side near the fixed part 45, a joining part 412 is set for inserting one end of the tube 38 for fixing. Some fixed holes 413 are set equally on each opposite side of the base 41, and every fixed hole 413 is corresponding to an aperture 421 of the left gearbox 42 or an aperture 431 of the right gearbox 43. Every pair of the fixed hole 413 and the aperture 421, 431 is fixed with a latch 414. A fixed post 422 set on each corner of the left gearbox 42 is corresponding to a fixed hole 432 of the right gearbox 43 and both fixed holes 422, 432 are fixed by a bolt.

A pivot hole 452 set on the toothlike adjuster 451 of the fixed part 45 is corresponding to a pivot hole 423 on the left gearbox 42 and a pivot hole 433 on the right gearbox 43, and is fixed by a penetrating pivot 454. And a jog 453 is set on each opposite side of the fixed part 45 for joining a connecting plate 6 which is connected to a LCD.

The power gear 44 comprises an electrical thread gear 441, a small gear 442, a small thread gear 443, a parent gear 444, a child gear 445 and a gear axle 446. The electrical thread gear 441, the parent gear 444 and the child gear 445 are set on the left gearbox 42. Both ends of the gear axle 446 penetrated through the small gear 442 and the small thread gear 443 is fixed on a clip 424 set in the left gearbox 42.

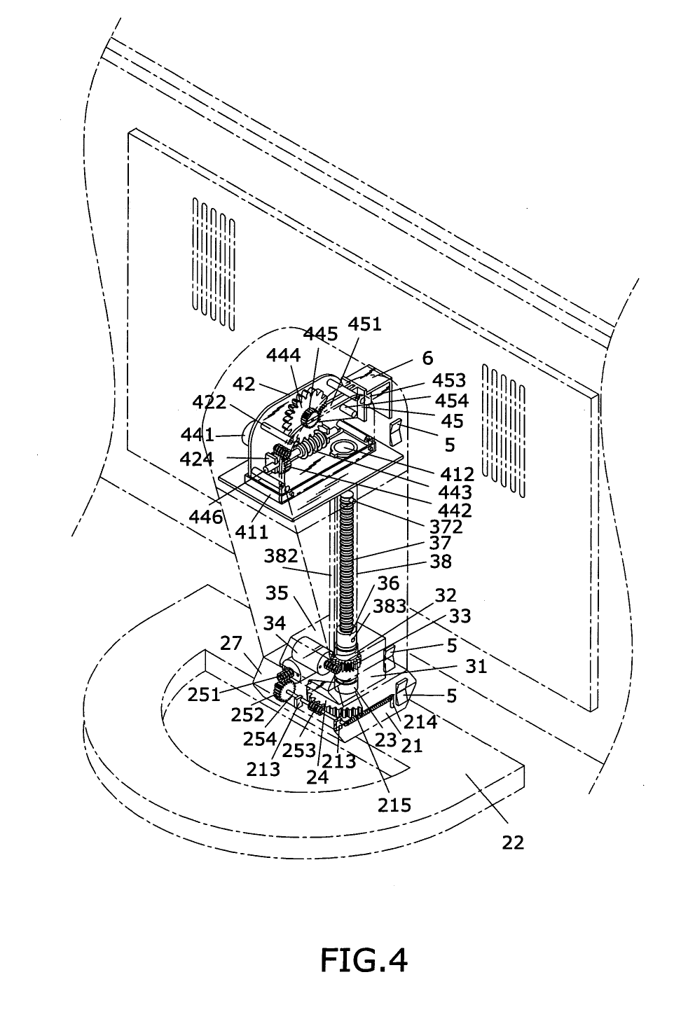

Referring to the FIG. 4, the rotating mechanism 2, the lifting mechanism 3 and the adjusting mechanism 4 are connecting to a power unit 5 each. The power unit 5 could be a contact switch type or a remote controlled switch type. The power unit 5 of the rotating mechanism 2 drives the gear part 24 through the rotating gear 25 for adjusting the lateral angle of the LCD. The electrical thread gear 34 of the lifting mechanism 3 drives the gear 33 on the rotating bearing 32 and then makes the tube 37 which joins tightly with the axle tube 36 to move vertically for changing the height position of the LCD. The power gear 44 of the adjusting mechanism 4 drives the toothlike adjuster 451 of the fixed part 45 for adjusting the pitch angle of the LCD.

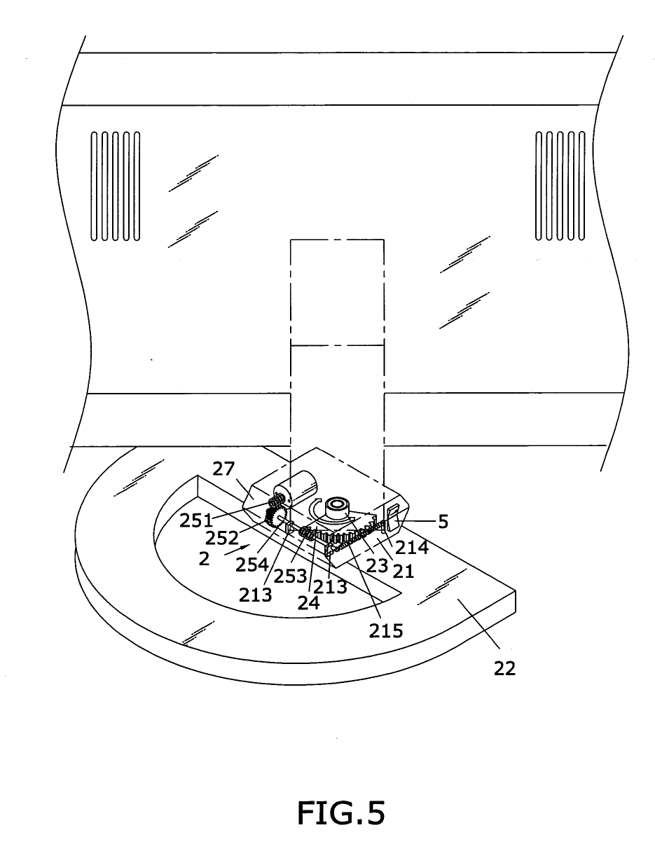

Referring to the FIG. 5, as the LCD is facing on a different position or the user sitting posture is deviated from the LCD, the user only need to switch on the power unit 5 of the rotating mechanism 2. The electrical thread gear 251 of the rotating gear 25 drives the small gear 252 and the small thread gear 253 to rotate. Then the gear part 24 is driven to rotate laterally. The user can adjust the lateral rotation angle until the program or the words shown on the LCD clearly without applying any manual effort.

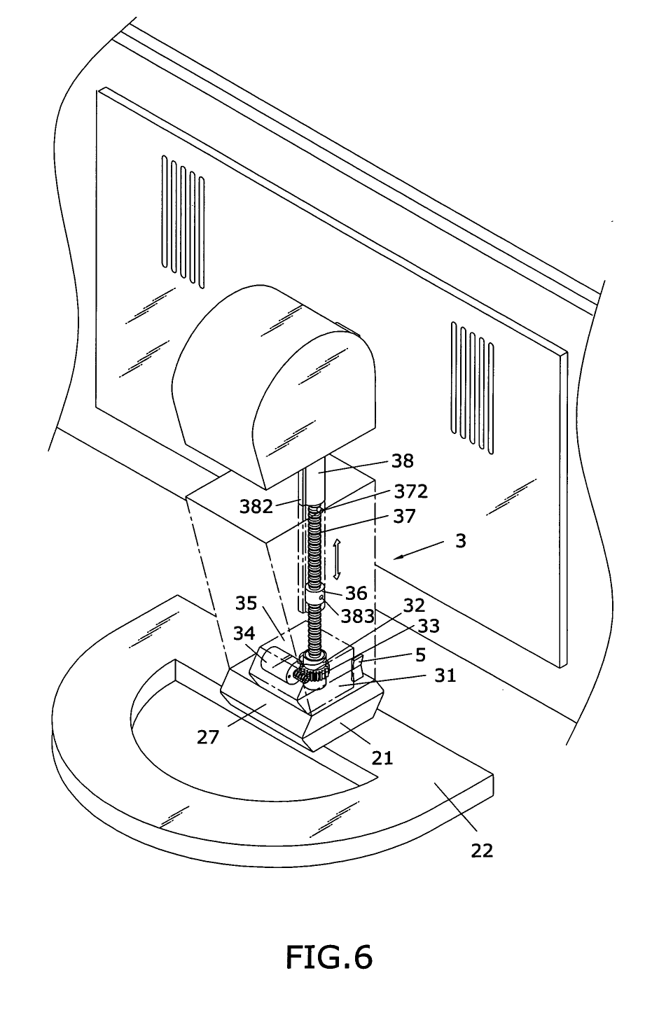

Referring to the FIG. 6, because the height ratio of the sitting posture of a child or a adult is different, it causes that the height difference between the user's sitting position and the LCD on a cabinet or a table is changing frequently. The user can just switch on the power unit 5 of the lifting mechanism 3 to drive the shank 37 of the rotating bearing 32 to self rotate through the electrical thread-gear 34. Then, because the prominence 382 of the tube 38 is embedded in the opening 352 (unshown) of the box lid 35 and limits the axle tube 36 and the shank 37 to move vertically only, so as to the movement of the tube 38. This can achieve the goal of adjusting the height position of the LCD without any manual movement.

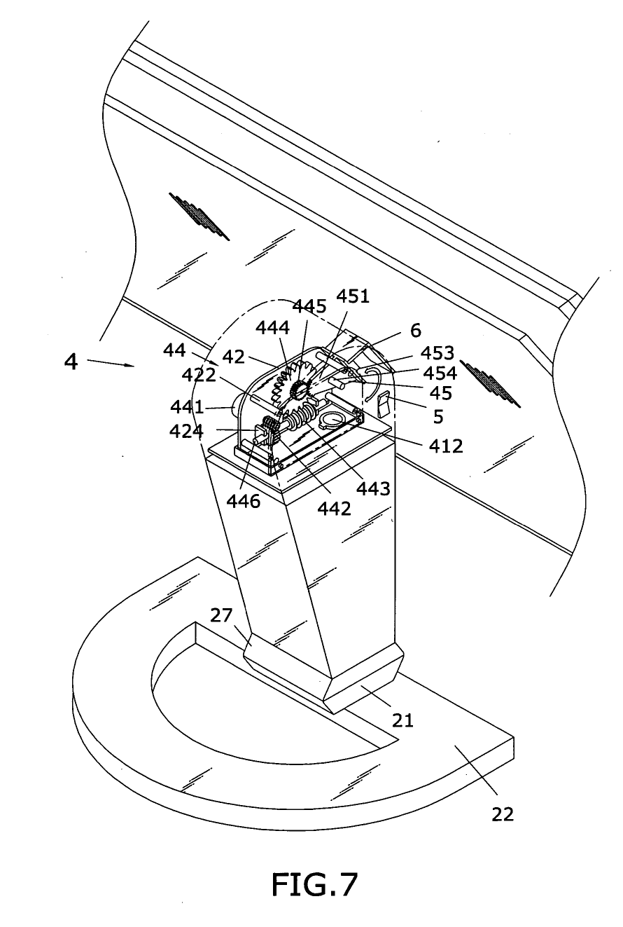

Referring to the FIG. 7, as the program or the words on the LCD can't be seen or read clearly just because of the deviated pitch angle of the LCD, the user only need to switch on the power unit 5 of the adjusting mechanism 4 to drive the electrical thread gear 441 of the power gear 44, and then the electrical thread gear 441 drives the small gear 442. The small gear 442 drives the parent gear 444 through the thread gear 443. Then, the child gear 445 set on the parent gear 444 drives the toothlike adjuster 451 of the fixed part 45 to adjust the pitch angle of the LCD without pulling the backside of the LCD manually.

To summarize the above statements, the LCD power-driven structure of this invention applies the power unit 5 on every gear in above mentioned mechanisms to control the adjustment of the lateral angle, the pitch angle and the height position without manual effort. So this invention improves the economic efficiency of the convenience and the utility of the prior LCD 1.

Obviously the invention is susceptible to changes or alternations without defeating its practicability. Therefore, the preferred embodiment shown in the drawings and described herein is not confined.

What is claimed are:

1. A Liquid Crystal Display (called LCD as following) power-driven structure comprises a rotating mechanism which contains:
a pedestal being set on a bracket of a LCD;
a pivot trough being set on said pedestal and joining a bearing;
a gear part being set on said bearing and being driven by a rotating gear;
a pivot hole being set on said gear part and being corresponding to a hollow of said bearing and a hollow of said pivot trough;
a shaft penetrating said pivot hole and said hollows;
a bearing and a hollow set on a cover being penetrated by said shaft;
a power unit.

2. The LCD power-driven structure according to claim 1 and further including:
an electrical thread gear, a small gear, a small thread gear and a gear axle composing said rotating gear;
a setting part being set on said pedestal for fixing said electrical thread gear;
a clipping part being set in said pedestal and fixing said gear axle,
said gear axle penetrating said small gear and said small thread gear.

3. The LCD power-driven structure according to claim 1 and further including:
said power unit being a contact switch type.

4. The LCD power-driven structure according to claim 1 and further including:
said power unit being a remote controlled switch type.

5. The LCD power-driven structure according to claim 1 and further including:
a hooking post being set in said pedestal;
one end of an elastic part hooking on said hooking post and the other end of said elastic part hooking on one end of said gear axle.

6. A LCD power-driven structure comprises a lifting mechanism which contains:
a box being set on a cover and containing a pivot trough which is penetrated by a shaft;
a rotating bearing being set on said pivot trough;
a gear being set around outside of said rotating bearing and being driven by an electrical thread gear;
a box lid being set on said rotating bearing;
an axle tube being set on said box lid and being penetrated by said shank into said rotating bearing;
a tube covering said shank and joining tightly with said axle tube;
a power unit.

7. The LCD power-driven structure according to claim 6 and further including:
a containing part being set inside of said box and fixing said electrical thread gear.

8. The LCD power-driven structure according to claim 6 and further including:
an inserting hole being set on one end of said shank;
a latch penetrating said inserting hole.

9. The LCD power-driven structure according to claim 6 and further including:
a hole being set on said box lid;
an opening being set on the side of said hole and propping a prominence set on said tube;
a fixed hole set on said axle tube being corresponding to a fixed hole set on one end of said tube;
a latch penetrating said fixed holes.

10. The LCD power-driven structure according to claim 6 and further including:
said power unit being a contact switch type.

11. The LCD power-driven structure according to claim 1 and further including:
said power unit being a remote controlled switch type.

12. A LCD power-driven structure comprises an adjusting mechanism which contains:
a base set on a tube;
a left gearbox with a power gear and a right gearbox being set on each opposite side of said base;
a fixed part being set between said left gearbox and said right gearbox;
a toothlike adjuster being extended from said fixed part and being driven by said power gear;
a power unit.

13. The LCD power-driven structure according to claim 12 and further including:
said power unit being a contact switch type.

14. The LCD power-driven structure according to claim 12 and further including:
said power unit being a remote controlled switch type.
